(19) United States
(12) Patent Application Publication
(10) Pub. No.: US 2011/0133997 A1
(43) Pub. Date: Jun. 9, 2011

(54) BUILT-IN ANTENNA APPARATUS SERVED AS STYLUS PEN IN PORTABLE TERMINAL

(75) Inventor: Seung-Hak LEE, Hwaseong-si (KR)

(73) Assignee: SAMSUNG ELECTRONICS CO. LTD., Suwon-si (KR)

(21) Appl. No.: 12/961,853

(22) Filed: Dec. 7, 2010

(30) Foreign Application Priority Data
Dec. 9, 2009 (KR) 10-2009-0121559

(51) Int. Cl. H01Q 1/24

(52) U.S. Cl. 343/702

(57) ABSTRACT

A built-in antenna apparatus for digital broadcasting reception in a portable terminal is provided. The apparatus includes a digital broadcasting reception module installed in a main board of the portable terminal, a fixing piece slidably installed in a guide slit having a specific length and disposed on a side of the broadcasting reception module, an electrical connection element for electrically connecting the fixing piece and the digital broadcasting reception module, and a built-in antenna detachably connected to an end of the fixing piece, insertable inside the portable terminal together with the fixing piece, having a specific length, and is electrically connected to the digital broadcasting reception module, wherein the built-in antenna is useable as a stylus pen when detached from the fixing piece.

### PRIORITY

This application claims the benefit under 35 U.S.C. §119(a) of a Korean patent application filed in the Korean Intellectual Property Office on Dec. 9, 2009 and assigned Serial No. 10-2009-0121559, the entire disclosure of which is hereby incorporated by reference.

### BACKGROUND OF THE INVENTION

1. Field of the Invention

The present invention relates to a built-in antenna apparatus for receiving a broadcast. More particularly, the present invention relates to a built-in antenna apparatus that serves as a stylus pen for effective space utilization.

2. Description of the Related Art

In general, portable terminals have various shapes and can be classified according to a closing/opening mechanism of a sub body when a user makes a call. In addition, to satisfy a user's demand, portable terminals are becoming lighter, thinner, and generally smaller in size. The portable terminals have gradually evolved from a typical bar-type terminal to a flip-type terminal, a folder-type terminal, a slide-type terminal, a popup-type terminal, a slide-and-rotation-type terminal, etc., to cope with the user's demand. Recently, the bar-type terminal is gaining popularity due to an advantage in that the entire part of the terminal can be used as a display device and a touch screen.

In addition to typical telephony functions, various additional functions are added to the portable terminals, thereby encouraging customers to purchase new portable terminals. For example, a speaker device capable of realizing polyphony melodies is installed, and a mega-pixel color display device is implemented. In addition to a basic call function, an MPeg-1 audio layer 3 (MP3) player is used to implement a music listening function in the portable terminals. Furthermore, the portable terminals provide not only various game contents using the display device but also a digital broadcasting service such as Digital Multimedia Broadcasting (DMB), Digital Video Broadcasting-Handheld (DVB-H), Integrated Services Digital Broadcasting-Terrestrial (ISDB-T), etc.

When receiving the digital broadcasting service, a device for transmitting/receiving external signals uses an antenna for communication and an extra antenna for broadcasting. For example, the DMB operates at a frequency of about 180 to 210 MHz, and the DVB-H or the ISDB-T operates at a frequency of 470 to 862 MHz. Therefore, in order to receive a broadcasting signal operating at a low frequency band, an antenna apparatus having a relatively larger volume than the antenna apparatus for communication is required.

Conventionally, a portable terminal is provided with an external antenna apparatus for digital broadcasting reception or a protrusion type or built-in type antenna apparatus for broadcasting reception.

Recently launched portable terminals employ a display device implemented with a touch screen, and are provided together with a stylus pen for inputting data or otherwise controlling the touch screen. Such a digital broadcasting antenna apparatus or a stylus pen is easy to use, but has a risk of loss and a very low portability.

Therefore, there is an effort to maximize the portability by integrating both the stylus pen and the antenna apparatus for digital broadcasting reception with the portable terminal. As one example, a digital antenna apparatus is built inside the portable terminal, and a stylus pen is also built inside the portable terminal.

However, since the digital broadcasting antenna apparatus and the stylus pen both have relatively large volume as described above, when they are built inside the terminal, a space for mounting the antenna apparatus and the stylus pen is additionally required, which adversely affects the realization of the slim-sized portable terminal.

### SUMMARY OF THE INVENTION

An aspect of the present invention is to address at least the above-mentioned problems and/or disadvantages and to provide at least the advantages described below. Accordingly, an aspect of the present invention is to provide a built-in antenna apparatus that serves as a stylus pen for a portable terminal that is implemented to contribute to a design of a slim-sized terminal.

Another aspect of the present invention is to provide a built-in antenna apparatus that serves as a stylus pen for a portable terminal which is easy to use and is implemented to prevent a risk of loss.

In accordance with an aspect of the present invention, a built-in antenna apparatus, serving as a stylus pen, for digital broadcasting reception of a portable terminal is provided. The apparatus includes a digital broadcasting reception module installed in a main board of the terminal, a fixing piece slidably installed in a guide slit having a specific length and disposed on a side of the broadcasting reception module, an electrical connection element for electrically connecting the fixing piece and the digital broadcasting reception module, and a built-in antenna detachably connected to an end of the fixing piece, insertable inside the terminal together with the fixing piece, having a specific length, and electrically connected to the digital broadcasting reception module, wherein the built-in antenna is used as the stylus pen when detached from the fixing piece.

In accordance with another aspect of the present invention, a built-in antenna apparatus is provided. The apparatus includes a main board, a fixing piece slidably installed in a guide slit, an electrical connection element for electrically connecting the fixing piece and the main board, and an antenna detachably connected to an end of the fixing piece and insertable inside the portable terminal with the fixing piece, wherein the antenna is useable as a stylus pen when detached from the fixing piece.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of certain exemplary embodiments of the present invention will be more apparent from the following description taken in conjunction with the accompanying drawings, in which:

FIG. 1 is a perspective view of a built-in antenna apparatus that serves as a pen according to an exemplary embodiment of the present invention;

FIG. 2 is a perspective view illustrating a part of a built-in antenna apparatus that serves as a stylus pen according to an exemplary embodiment of the present invention;

FIG. 3 illustrates a state in which a built-in antenna that serves as a stylus pen is detached from a terminal according to an exemplary embodiment of the present invention; and

FIG. 4 illustrates a state in which a built-in antenna that serves as a stylus pen is located inside a terminal according to an exemplary embodiment of the present invention.

Throughout the drawings, it should be noted that like reference numbers are used to depict the same or similar elements, features, and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. In addition, descriptions of well-known functions and constructions may be omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention is provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

By the term “substantially” it is meant that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

Although a bar-type terminal is used herein to illustrate the use of a built-in antenna that serves as a stylus pen, the present invention is not limited thereto. Thus, the present invention can apply to any type of terminal capable of receiving a digital broadcast.

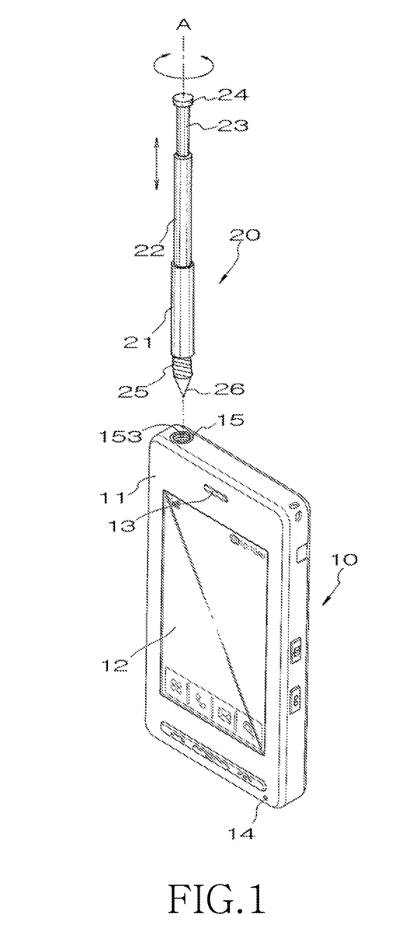

FIG. 1 is a perspective view of a built-in antenna apparatus that serves as a pen according to an exemplary embodiment of the present invention.

Referring to FIG. 1, a built-in antenna 20 is selectively fixed to a fixing piece 15 installed in an upper part of a body 11 of a portable terminal 10. As will be described below, the fixing piece 15 is configured to be slid within the terminal 10, so that the built-in antenna 20 may be entirely inserted inside the terminal.

The built-in antenna 20 may be used as a stylus pen when detached from the terminal 10. The built-in antenna 20 includes a plurality of vertical cylinders 21, 22, and 23. Although it is shown herein that diameters of the protrusion type vertical cylinders 21, 22, and 23 decrease in proportion to their extended heights, an alternative is also possible in which the diameters increase in proportion to their extended heights. A head 24 is installed in the uppermost vertical cylinder among the plurality of vertical cylinders 21, 22, and 23, so as to facilitate extraction of the built-in antenna or protrusion of the vertical cylinders when the built-in antenna is inserted into the terminal.

In an exemplary embodiment, the head 24 can be implemented such that it is aligned with a surface of the body 11 when the built-in antenna 20 is inserted into the terminal 10.

A lower part of the lowermost vertical cylinder 21 is installed with a joining member 25 which is inserted to a joining hole 153. An end of the joining member 25 is implemented with a tip 26 having a relatively sharp end to facilitate a touch input on a touch screen. In an exemplary embodiment, all components of the built-in antenna are formed with a metal material so that they can operate as an antenna to receive a digital broadcast without the need for another antenna. However, the present invention is not limited thereto. Thus, an additional antenna radiator for digital broadcasting may be built inside the cylinders 21, 22, and 23.

In the illustrated example, the portable terminal 10 is a bar-type terminal and has a display unit 12 installed in a full surface of the body 11. The display unit 12 may include a high quality color touch screen module, and is used as a touch area. For example, the display unit 12 may function as a touch area in conjunction with the antenna 20 which, when the antenna 20 is detached from the terminal, may be used as a stylus pen. An upper part of the display unit 12 includes an ear piece 13 for receiving the voice of a counterpart user. A lower part of the display unit 12 is installed with a microphone 14 for transmitting the voice of a user of the portable terminal 10.

The fixing piece 15 is installed in an upper part of the body 11. After the built-in antenna 20 is joined to the joining hole 153 of the fixing piece 15 by using a specific mechanism, the fixing piece 15 can be inserted inside the portable terminal 10, for example by sliding inside the portable terminal 10.

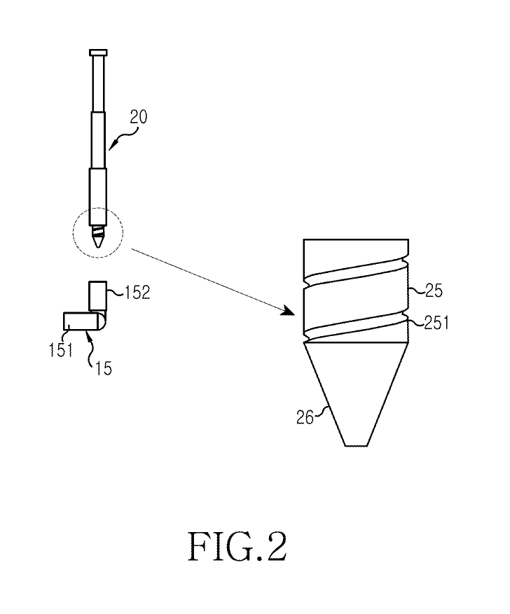

FIG. 2 is a perspective view illustrating a part of a built-in antenna apparatus that serves as a stylus pen according to an exemplary embodiment of the present invention.

Referring to FIG. 2, since the built-in antenna 20 may also be used as the stylus pen, the joining member 25 has the tip 26 having a sharp end. In an exemplary embodiment, a female screw thread 251 is spirally formed along an outer circumferential surface of the joining member 25, and a mail screw thread is formed in the joining hole 153 of the fixing piece 15, so that the joining member 25 can be fixed to the joining hole 153 of the fixing piece 15 in a screwing manner. Therefore, the built-in antenna 20 can be selectively joined with or detached from the fixing piece 15 by rotating about an axis A of FIG. 1. However, the present invention is not limited thereto, and thus other well-known structures can also be used as long as attachment and detachment are possible.

The fixing piece 15 includes a flexible end 151 and a free end 152 which is bonded in a hinge manner so as to rotate about the flexible end 151. The free end 152 has a hollowed shape having a circular cross-section. The aforementioned male screw thread is formed in a hollowed part (of the joining hole 153 of FIG. 1). Therefore, the joining member 25 of the built-in antenna 20 can be selectively inserted in a screwing manner to the hollowed part 153 of the free end 152. In an exemplary embodiment, the flexible end 151 can be installed in a rotatable manner without the aid of other elements.

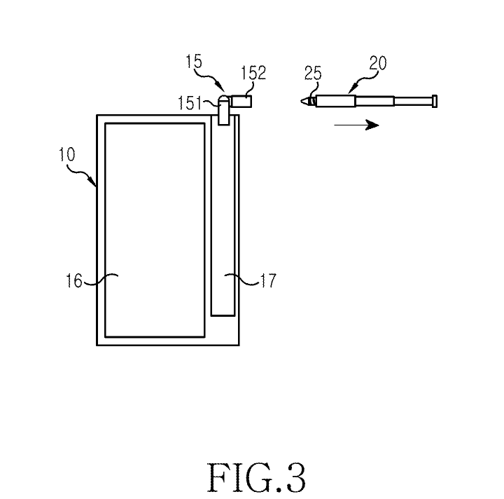

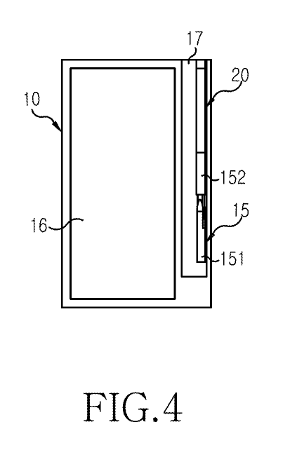

FIG. 3 illustrates a state in which a built-in antenna that serves as a stylus pen is detached from a terminal according to an exemplary embodiment of the present invention. FIG. 4 illustrates a state in which a built-in antenna that serves as a stylus pen is located inside a terminal according to an exemplary embodiment of the present invention.

Referring to FIG. 3 and FIG. 4, the portable terminal 10 includes a main board 16 and a guide slit 17. The guide slit 17 is formed on one side of the main board 16 to smoothly guide the fixing piece 15. The guide slit 17 is formed with a length such that it can be sufficiently inserted after the vertical cylinders 21, 22, and 23 of the built-in antenna 20 are entirely folded. The main board 16 includes a digital broadcasting module (not shown). Although not shown, the main board 16 is electrically connected to the fixing piece 15 by means of a well-known electrical connection element. The electrical connection element can be implemented with various methods such as a well-known Flexible Printed Circuit (FPC), a conductive plate spring, bushing engagement, etc. In an exemplary embodiment, the fixing piece 15 is formed with a metal material. That is, one end of the fixing piece 15 is electrically connected to the digital broadcasting module, and the other end thereof is electrically connected by being installed within a flexibility range of the flexible end 151 of the fixing piece 15 so as to be selectively brought in contact.

In an exemplary embodiment, the fixing piece 15 can be electrically connected with the digital broadcasting module when the built-in antenna 20 is entirely inserted into the guide slit 17 or when the built-in antenna 20 is entirely extended. However, the present invention is not limited thereto, and thus the fixing piece 15 may always be electrically connected by means of an FPC having a specific length.

Therefore, when receiving a digital broadcast, a user of the portable terminal 10 can receive the digital broadcast in a state in which the built-in antenna 20 is inserted into the joining hole 153 of the free end 152 of the fixing piece 15 installed in the terminal 10 in a screwing manner and thereafter is entirely inserted or entirely extended.

Meanwhile, when the user intends to perform a touch mode using the display unit 12 without watching the broadcast, the user may detach the built-in antenna 20 from the fixing piece 15 and hold the head 24 to protrude each of the vertical cylinders 21, 22, and 23 to a maximum extent possible. In this manner, the built-in antenna 20 may be used as the stylus pen.

According to exemplary embodiments of the present invention, a built-in antenna apparatus that serves as a stylus pen is used as a digital broadcasting antenna in a state in which the antenna is placed inside the terminal in a normal condition, thereby avoiding risk of loss. In addition, since the antenna apparatus is also used as the stylus pen, a space for mounting the antenna and the stylus pen in the terminal is effectively utilized, thereby contributing to a design of a slim-sized terminal.

While the present invention has been shown and described with reference to certain exemplary embodiments thereof, it will be understood by those skilled in the art that various changes in form and details may be made therein without departing from the spirit and scope of the present invention as defined by the appended claims and their equivalents.

What is claimed is:

1. A built-in antenna apparatus of a portable terminal, the apparatus comprising:
a digital broadcasting reception module installed in a main board of the portable terminal;
a fixing piece slidably installed in a guide slit having a specific length and disposed on a side of the broadcasting reception module;
an electrical connection element for electrically connecting the fixing piece and the digital broadcasting reception module; and
a built-in antenna detachably connected to an end of the fixing piece, insertable inside the portable terminal together with the fixing piece, having a specific length, and electrically connected to the digital broadcasting reception module,
wherein the built-in antenna is usable as a stylus pen when detached from the fixing piece.

2. The apparatus of claim 1, wherein the built-in antenna comprises a metallic material, and operates as an antenna radiator by means of a plurality of retractable type hollow cylinders.

3. The apparatus of claim 2, wherein a lower part of the lowermost cylinder among the plurality of cylinders is formed with a joining member to be fixed to the fixing piece, and a lower part of the joining member is formed with the stylus pen having a sharp end.

4. The apparatus of claim 3, wherein an upper part of the uppermost cylinder among the plurality of cylinders comprises a head having a specific size, and the head is approximately aligned with an outer circumferential surface of the portable terminal when the built-in antenna is entirely inserted into the portable terminal.

5. The apparatus of claim 3, wherein the joining member has a circular cross-section and has an outer circumferential surface formed with a female screw thread or a male screw thread, and the fixing piece has an inner circumferential surface formed with a joining hole having a corresponding screw thread so as to enable selective fixing by inserting the joining member to the joining hole in a screwing manner.

6. The apparatus of claim 5,
wherein the fixing piece includes a flexible end flexibly installed in the guide slit of the portable terminal and a free end bonded in a hinge manner so that the free end can rotate in the flexible end, and
wherein the joining hole is formed in the free end.

7. The apparatus of claim 6, wherein, when the fixing piece is entirely extracted from the portable terminal, only the free end is exposed to the outside of the portable terminal and is rotatable in various angles.

8. The apparatus of claim 1, wherein, when entirely inserted or entirely extended, the built-in antenna operates by being electrically connected to the digital broadcasting reception module.

9. The apparatus of claim 8, wherein the electrical connection element comprises at least one of a Flexible Printed Circuit (FPC) for electrically connecting the fixing piece with the digital broadcasting reception module and a metal plate spring for selectively connecting the fixing piece and the digital broadcasting reception module.

10. A portable terminal including an antenna apparatus, the apparatus comprising:
a main board;
a fixing piece slidably installed in a guide slit;
an electrical connection element for electrically connecting the fixing piece and the main board; and
an antenna detachably connected to an end of the fixing piece and insertable inside the portable terminal with the fixing piece,
wherein the antenna is useable as a stylus pen when detached from the fixing piece.

11. The portable terminal of claim 10, wherein the antenna comprises a metallic material and operates as an antenna radiator by means of a plurality of retractable type hollow cylinders.

12. The portable terminal of claim 11, wherein a lower part of the lowermost cylinder among the plurality of cylinders is formed with a joining member to be fixed to the fixing piece, and a lower part of the joining member is formed with the stylus pen having a sharp end.

13. The portable terminal of claim 12, wherein an upper part of the uppermost cylinder among the plurality of cylinders comprises a head having a specific size, and the head is approximately aligned with an outer circumferential surface of the portable terminal when the antenna is inserted into the portable terminal.

14. The portable terminal of claim 12, wherein the joining member has a circular cross-section and has an outer circumferential surface formed with a female screw thread or a male screw thread, and the fixing piece has an inner circumferential surface formed with a joining hole having a corresponding screw thread so as to enable selective fixing by inserting the joining member to the joining hole in a screwing manner.

15. The portable terminal of claim 14,
wherein the fixing piece includes a flexible end flexibly installed in the guide slit of the portable terminal and a free end bonded in a hinge manner so that the free end can rotate in the flexible end, and
wherein the joining hole is formed in the free end.

16. The portable terminal of claim 15, wherein, when the fixing piece is extracted from the portable terminal, only the free end is externally exposed and is rotatable in various angles.

17. The portable terminal of claim 10, wherein, when entirely inserted or entirely extended, the antenna operates by being electrically connected to the main board.

18. The portable terminal of claim 17, wherein the electrical connection element comprises at least one of a Flexible Printed Circuit (FPC) for electrically connecting the fixing piece with the main board and a metal plate spring for selectively connecting the fixing piece and the main board.
